(19) United States
(12) Patent Application Publication
(10) Pub. No.: US 2010/0249282 A1
(43) Pub. Date: Sep. 30, 2010

(54) ENVIRONMENTALLY FRIENDLY ELECTRONIC DEVICE HOUSINGS

(75) Inventor: Georgios Topoulos, Meyrin (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/730,346

(22) Filed: Mar. 24, 2010

Related U.S. Application Data
(60) Provisional application No. 61/164,543, filed on Mar. 30, 2009.

(51) Int. Cl. C08L 97/00; C08L 77/00; C08K 3/26; C08K 3/34; C08K 3/30; C08K 3/10

(52) U.S. Cl. 524/13; 524/606; 524/9; 524/15; 524/425; 524/451; 524/449; 524/443; 524/445; 524/447; 524/423; 524/424; 524/435; 524/413

(57) ABSTRACT

The present invention relates to the field of natural fiber reinforced polyamide compositions, particularly it relates to natural fiber reinforced polyamide compositions for manufacturing environmentally friendly electronic device housings that exhibit good mechanical properties.

### CROSS REFERENCE TO RELATED APPLICATIONS

This application claims the benefit of U.S. Provisional Application No. 61/164,543, filed Mar. 30, 2009, which is incorporated herein by reference in its entirety.

### FIELD OF THE INVENTION

The present invention relates to the field of natural fiber reinforced polyamide compositions, particularly it relates to natural fiber reinforced polyamide compositions for manufacturing environmentally friendly electronic device housings.

### BACKGROUND OF THE INVENTION

Thermoplastic polyamide compositions are desirable for use in a wide range of applications including parts used in automobiles, electrical/electronic parts, household appliances and furniture because of their good mechanical properties, heat resistance, impact resistance and chemical resistance and because they may be conveniently and flexibly molded into a variety of articles of varying degrees of complexity and intricacy.

As an example, thermoplastic polyamide compositions are particularly suited for making housings for hand held electronic devices (also called portable electronic devices), such as mobile telephones, personal digital assistants, laptop computers, tablet computers, global positioning system receivers, portable games, radios, cameras and camera accessories. Such applications are highly demanding applications since they require polyamide compositions that exhibit a good balance of mechanical properties and aesthetical aspect while not interfering with the intended operability of the hand held electronic device, e.g. through absorption of electromagnetic waves.

In an attempt to improve mechanical properties, it has been the conventional practice to add various inorganic reinforcements to the resin, like for example glass fibers, glass flakes, carbon fiber, mica, wollastonite, talc, calcium carbonate so as to obtained reinforced polyamide compositions. Moreover, it is important that the housings of such devices made from polyamide compositions be able to withstand the rigors of frequent use. It is often desirable that such compositions have good stiffness and impact resistance, that they exhibit excellent surface appearance and that they can be readily painted.

The portable electronic device industry and their suppliers are increasingly concerned about the environmental footprint, greenhouse gas emissions and depletion of natural resources. Therefore it is increasingly desirable or necessary to use materials derived from renewable resources and having overall low negative environmental impact.

As mentioned above, glass fibers are currently used in thermoplastic polymers since they have an excellent dispersion in thermoplastic polymers and lead to good mechanical properties under standard conditions. Neverthless, glass fibers are formed through an energy intensive process requiring large amounts of power thus increasing their impact on the environment and associated cost of manufacture. Morever, and in addition to the drawback that glass fibers may be abrasive thus making them dangerous to work with, glass fibers are difficult to dispose of at the end of their lifetimes. Glass fiber reinforced compositions cannot be incinerated as the residues tend to cause furnace damage. A method of disposal is to discard the waste in landfill sites, which is not only problematic from an environmental perspective but is also very expensive. With the current and general desire to have thermoplastic compositions that are environmentally friendly, compositions comprising poly(lactic acid) (PLA) as a material being polymerized from renewable sources and being degradable under composting conditions have been developed.

U.S. Pat. No. 7,445,835 discloses a composition comprising a biodegradable resin such as for example poly(lactic acid) (PLA) and kenaf fibers. Such compositions are said to be useful for manufacturing electrical and electronic equipment. Since portable electronic device covers are a particularly demanding materials application thus requiring high mechanical performance, the use of such compositions for manufacturing portable electronic device covers is limited due to the brittleness of PLA.

WO2008/107615 discloses a polyamide composition comprising from 10 to 60 wt-% of poly(lactic acid). Such compositionvs are said to be useful for manufacturing portable electronic device covers. Neverthless, resin compositions comprising poly(lactic acid) (PLA) may suffer from deterioration of their mechanical properties upon use and time especially if the electronic equipment is used in a humid and hot place due to the biodegradabililty of the resin.

There is a need for electronic housings that include an envrionmentally friendly polyamide composition having good mechanical properties.

### SUMMARY OF THE INVENTION

It has been found that a resin composition comprising a) at least one polyamide; and b) a natural fiber material exhibits good mechanical properties.

In a first aspect, the invention provides an electronic device housing made of a resin composition comprising at least one polyamide and a natural fiber material.

In a second aspect, the invention provides a process for making an electronic device housing comprising a step of shaping the resin composition comprising at least one polyamide and a natural fiber material.

### DETAILED DESCRIPTION

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The resin composition described herein is particularly suited for manafucturing an electronic device housing. By “electronic device housing” is meant a housing, cover, backbone, frame work, or the like of the device. The housing may be a single article or comprise two or more components. By “backbone” is meant a structural component onto which other components of the device, such as electronics, microprocessors, screens, keyboards and keypads, antennas, battery sockets, and the like are mounted. The backbone may be an interior component that is not visible or only partially visible from the exterior of the telephone. The housing may provide protection for internal components of the device from impact and contamination and/or damage from environmental agents (such as liquids, dust, and the like). Housing components such as covers may also provide substantial or primary structural support for and protection against impact of certain components having exposure to the exterior of the device such as screens and/or antennas. Preferably, the electronic device described herein is designed to be hand held, i.e. to be a hand held electronic device or portable electronic device.

By “hand held electronic device” is meant an electronic device that is designed to be conveniently transported and used in various locations. Representative examples of hand held electronic devices include mobile telephones, personal digital assistants, laptop computers, tablet computers, radios, cameras and camera accessories, watches, calculators, music players, global positioning system receivers, portable games, hard drives and other electronic storage devices, and the like. Preferably, the hand held electronic device housing according to the present invention is in a form of a mobile telephone housing, i.e. the hand held electronic device housing according to the present invention is preferably a mobile telephone housing.

The electronic device housing according to the present invention is made from a resin composition comprising at least one polyamide. The at least one polyamide is preferably present from at or about 40 to at or about 95 wt-%, more preferably from at or about 60 to at or about 95 wt-%, and still more preferably from at or about 70 to at or about 95 wt-%, the weight percentage being based on the total weight of the resin composition.

Polyamides are condensation products of one or more dicarboxylic acids and one or more diamines, and/or one or more aminocarboxylic acids, and/or ring-opening polymerization products of one or more cyclic lactams. In the context of this invention, the term “polyamide” also refers to copolymers derived from two or more such monomers and blends of two or more fully aliphatic polyamides. Linear, branched, and cyclic monomers may be used.

Suitable dicarboxylic acids include, but are not limited to, adipic acid (C6), pimelic acid (C7), suberic acid (C8), azelaic acid (C9), sebacic acid (C10), dodecanedioic acid (C12) and tetradecanedioic acid (C14), terephthalic acid (abbreviated as “T” in polyamide designations), and isophthalic acid (abbreviated as “I” in polyamide designations). Preferred dicarboxylic acids are sebacic acid, dodecanedioic acid, tetradecanedioic acid, terephthalic acid and mixtures thereof.

Diamines can be chosen among diamines having four or more carbon atoms, including, but not limited to tetramethylenediamine, hexamethylenediamine, octamethylenediamine, nonamethylenediamine, 2-methylpentamethylenediamine; 2-methyloctamethylenediamine; trimethylhexamethylenediamine, decamethylenediamine, undecamethylenediamine, dodecamethylenediamine, tridecamethylenediamine; tetramethylenediamine, pentamethylenediamine and hexamethylenediamine. Preferred diamines are hexamethylenediamine, decamethylenediamine and dodecamethylenediamine and mixtures thereof.

Preferably the at least one polyamide is selected from PA6,10 (poly(hexamethylene sebacamide)), PA6,14 (poly(hexamethylene tetradecanoamide)), PA10,10 (poly(decamethylene sebacamide)), PA10,12 (poly(decamethylene dodecanoamide)), PA1014 (poly(decamethylene tetradecanoamide)), PA12,10 (poly(dodecamethylene sebacamide)), PA12,12 (poly(dodecamethylene dodecanoamide)), PA610/6T (hexamethylene sebacamide/hexamethylene terephthalamide copolyamide), PA612/6T (hexamethylene dodecanoamide/hexamethylene terephthalamide copolyamide), PA1010/10T (decamethylene sebacamide/decamethylene terephthalamide copolyamide) and copolymers and mixtures of the same. More preferably, the at least one polyamide is PA10,10.

Since the the electronic device housing according to the present invention is made from a resin composition comprising a natural fiber material, and since this material may be sensitive to decomposition or deterioration resulting from high temperature exposure, it is preferred that the at least one polyamide has a melting point less than or equal to 230° C. as measured according to ISO 3146C.

According to another embodiment of the present invention, the to electronic device housing according to the present invention is made from a resin composition comprising at least one polyamide which is partially or entirely derived from renewable resources, i.e. the resin composition comprises at least one renewable polyamide. In recent years, bio-based resins have attracted attention from the viewpoint of environmental conservation and it has become a general trend to replace fossil fuel resources with renewable resources for use as fuel and raw materials for the petroleum-based products. For this reason, the electronic device industry and their suppliers are increasingly concerned about the environmental footprint, greenhouse gas emissions and depletion of natural resources. Therefore it is increasingly desirable or necessary to use materials derived from renewable resources and having overall low negative environmental impact.

As mentioned above, polyamides are condensation products of one or more dicarboxylic acids and one or more diamines, and/or one or more aminocarboxylic acids, and/or ring-opening polymerization products of one or more cyclic lactams. Polyamides which are partially or entirely derived from renewable resources are prepared from aliphatic dicarboxylic acids and aliphatic diamines, at least one of which is bio-sourced or “renewable”. By “bio-sourced” or “renewable”, it is meant that the material is or can be replenished within a few years (unlike petroleum which requires thousands or millions of years) for example by fermentation and other processes that convert biological materials, such as for example vegetable matter including grains, vegetable oils, cellulose, lignin, fatty acids; and animal matter including fats, tallow, oils such as whale oil, fish oils, into feedstock or into the final renewable polymer.

Examples of aliphatic dicarboxylic acids that are bio-sourced or renewable include linear dicarboxylic acid of Cₙ chain length where n=10 (decanedioic acid, also called sebacic acid), 12 (dodecanedioic acid) and 14 (tetradecanedioic acid). Bio-sources of the aliphatic dicarboxylic acids are available by well known fermentation processes combined with conventional isolation and purification processes. For instance, 1,14-tetradecanedioic acid is available by biofermentation of methyl myristate using Candida tropicalis according to the procedures disclosed in U.S. Pat. Nos. 6,004,784 and 6,066,480, hereby incorporated by reference. Other α,ω-alkanedicarboxylic acids are also available using similar fermentation methods with other fatty acids, or fatty esters. The aliphatic dicarboxylic acids can be isolated from the fermentation broth using well known procedures in the art. For instance, GB patent 1,096,326, discloses the ethyl acetate extraction of a fermentation broth, followed by esterification of the extract with methanol and sulfuric acid catalysis to provide the corresponding dimethyl ester of the dicarboxylic acid. A specific example of a bio-sourced aliphatic dicarboxylic acids available commercially is sebacic acid, that is derived from castor oil.

The aliphatic dicarboxylic acids derived from bio-sources, as disclosed above, can be converted to aliphatic diamines by conventional chemical methods such as disclosed in Chinese Patent 101088983, Dec. 19, 2007 entitled “Preparation of dodecanedioic acid decanediamine salt for use synthesizing polyamides.” Reacting decanedioic acid with ammonia at 134-200° C., followed by dehydration of the diamide at 200-400° C., provides sebacic dinitrile, that can be hydrogenated in the presence of Raney nickel catalyst in ethanol-potassium hydroxide solution at 50-125° C., to provide the 1,10-decanediamine. Other α,ω-alkanedicarboxylic acids can be converted to α,ω-alkane diamines using similar methods. Thus, the combination of fermentation and conventional chemical synthesis as disclosed above provides a bio-sourced family of α,ω-alkane diamines suitable for polyamide synthesis.
These bio-sources have a unique characteristic in that they all possess high levels of the carbon isotope ¹⁴C; as compared to fossil or petroleum sources of the dicarboxylic acids and aliphatic diamines. This unique isotope feature remains unaffected by non-nuclear, conventional chemical modifications. Thus the ¹⁴C isotope level in bio-sourced materials provides an unalterable feature that allows any downstream products, such as polyamides; or products comprising the polyamides such as electrical housings, to be unambiguously identified as comprising a bio-sourced material.

When at least one polyamide which is partially or entirely derived from renewable resources is used to manufacture the resin composition, preferably the at least one polyamide has a carbon content of at least 50 percent modern carbon (pMC), more preferably at least 70 pMC and still more preferably at least 90, pMC, all as determined with the ASTM-D6866 Biobased Determination Method B. Several commercial analytical laboratories have capabilities to perform ASTM-D6866 method. The analyses herein were conducted by Beta Analytics Inc. Miami Fla., USA.

The ASTM-D6866 method to derive a “Biobased content” relies on determining a ratio of the amount of radiocarbon (¹⁴C) in an unknown sample to that of a modern reference standard. The ratio is reported as a percentage with the units “pMC” (percent modern carbon). If the material being analyzed is a mixture of present day radiocarbon and fossil carbon (fossil carbon being derived from petroleum, coal, or a natural gas source), then the pMC value obtained correlates directly to the amount of Biomass material present in the sample.

The modern reference standard used in radiocarbon dating is a National Institute of Standards and Technology-USA (NIST-USA) standard with a known radiocarbon content equivalent approximately to the year AD 1950. AD 1950 was chosen since it represented a time prior to thermo-nuclear weapons testing which introduced large amounts of excess radiocarbon into the atmosphere with each explosion (termed “bomb carbon”). This was a logical point in time to use as a reference for archaeologists and geologists. For those using radiocarbon dates, AD 1950 equals “zero years old”. It also represents 100 pMC.

“Bomb carbon” in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. It's gradually decreased over time with today's value being near 107.5 pMC. This means that a fresh biomass material such as corn, vegetable oils, etc, and materials derived therefrom, would give a radiocarbon signature near 107.5 pMC. The radiocarbon dating isotope (14C), with its nuclear half life of 5730 years, clearly allows one to apportion specimen carbon between fossil carbon (“dead”) and biospheric (“alive”) feedstocks. Fossil carbon, depending upon its source, has very close to zero ¹⁴C content. Combining fossil carbon with present day carbon into a material will result is in a dilution of the present day pMC content. By presuming 107.5 pMC represents present day biomass materials and 0 pMC represents petroleum (fossil carbon) derivatives, the measured pMC value for that material will reflect the proportions of the two component types. Thus, a material derived 100% from present day vegetable oil would give a radiocarbon signature near 107.5 pMC. If that material was diluted with 50% petroleum derivatives, it would give a radiocarbon signature near 54 pMC.

A biomass content result is derived by assigning 100% equal to 107.5 pMC and 0% equal to 0 pMC. In this regard, a sample measuring 99 pMC will give an equivalent Biobased content result of 93%. This value is referred to as the “Mean Biobased Result” and assumes all the components within the analyzed material were either present day living or fossil in origin.

The results provided by the ASTM D6866 method are the Mean Biobased Result and encompasses an absolute range of 6% (plus and minus 3% on either side of the Mean Biobased Result) to account for variations in end-component radiocarbon signatures. It is presumed that all materials are present day or fossil in origin. The result is the amount of biobased component “present” in the material, not the amount of biobased material “used” in the manufacturing process.

The electronic device housing according to the present invention is made from a resin composition comprising a natural fiber material. By natural fiber material, it is meant any of material of plant origin or of animal origin. The natural fiber material is preferably present from at or about 5 to at or about 60 wt-%, more preferably from at or about 5 to at or about 40 wt-%, and still more preferably from at or about 5 to at or about 30 wt-%, the weight percentage being based on the total weight of the resin to composition.

Preferably, the natural fiber material is derived from vegetable sources such as for example from seed hair (e.g. cotton), stem plants (e.g. hemp, flax, bamboo; both bast and core fibers), leaf plants (e.g. sisal and abaca), agricultural fibers (e.g., cereal straw, corn cobs, rice hulls and coconut hair) or lignocellulosic fiber (e.g. wood, wood fibers, wood flour, paper and wood-related materials). These natural fiber materials are used alone inidividually, or a plurality of these fibers are used in combination as required. More preferably, the natural fiber material comprises at least one of the group consisting of kenaf, flax, wood, cotton, wool, bamboo, hemp, ramie, sisal, linen, jute, silk, grasses, rice hulls, bagasse and mixtures thereof; and still more preferably, the natural fiber material comprises at least one of the group consisting of kenaf, flax, wood, cotton, wool, and mixtures thereof.

For optimal mechanical properties, the natural fiber material has preferably an average diameter from at or about 5 to at or about 60 microns and more preferably from at or about 10 to at or about 40 microns, the average diameter being measured by electron microscopy. With the aim of optimizing the compounding of the resin composition according to the present invention, the natural fiber material has preferably an average length from at or about 1 to at or about 70 mm, more preferably from at or about 2 to at or about 30 mm, and still more preferably from from at or about 2 to at or about 6 mm, the average length being measured by by electron microscopy.

Preferably, the natural fiber material has a modulus from at or about 10 to at or about 100 GPa, more preferably from at or about 20 to at or about 80 GPa, the modulus being measured according to the method ASTM-D885.

The natural fiber material may optionally be subjected, before being mixed and blended with the at least one polyamide, to a treatment. Examples of such treatments include without limitation a superificial treatment to improve the adhesion of the natural fiber material with the polyamide by means of modification of the fibre surface by physical and/or to chemical methods (e.g. oxygen plasma, bleaching, delignification, dewaxing), grafting of monomers) drying the natural fiber material or cutting the natural fiber material to the preferred size.

Apart from the use of natural fiber materials for environmental benefits, this use leads also to other advantages such as for example, the abundant availability of the raw materials from renewable resources and their low cost.

Depending on the end-use application, the mechanical performance of the electronic device housing according to the present invention may be fine tuned by replacing a partial amount of the natural fiber material by one or more reinforcement agents. Examples of reinforcement agents include glass reinforcement agents and fillers such as calcium carbonate, carbon fibers, talc, mica, wollastonite, calcinated clay, kaolin, magnesium sulfate, magnesium silicate, barium sulphate, titanium dioxide, sodium aluminum carbonate, barium ferrite, and potassium titanate. Examples of glass reinforcement agents include a) non-circular (e.g. having the shape of, for example, an oval, elliptic, cocoon or rectangular) cross-sectional fibrous glass filler such as those described in EP 0190011 and in EP 196194; glass fibers having a circular cross section or glass flakes. When present, the one or more, the one or more reinforcement agents comprised in the resin composition described herein are selected from glass reinforcement agents and fillers such as calcium carbonate, carbon fibers, talc, mica, wollastonite, calcinated clay, kaolin, magnesium sulfate, magnesium silicate, barium sulphate, titanium dioxide, sodium aluminum carbonate, barium ferrite, potassium titanate and mixtures thereof. When a partial amount of the natural fiber material is replaced by one or more reinforcement agents, the resin composition preferably comprises up to at or about 15 wt-% of the one or more reinforcement agents and more preferably up to at or about 5 wt-%, the weight percentage being based on the total weight of the resin composition.

The resin composition described herein may further comprise one or more compatibilizing agents and/or sizing agents so as to improve the interfacial adhesion of the natural fiber material with the polyamide. to Examples of compatibilizing agents are modified olefin homopolymers and/or copolymers. Modified olefin homopolymers and/or copolymers means that the polymer is grafted and/or copolymerized with organic functionalities such as for example acid, anhydride and/or epoxide functionalities. When present, the one or more compatibilizing agents and/or sizing agents comprise from at or about 0.1 to at or about 15 wt-%, or preferably from at or about 0.2 to at or about 10 wt-%, the weight percentage being based on the total weight of the resin composition.

The resin composition described herein may further comprise one or more antioxidants. Examples of antioxidants include without limitation phosphate or phosphonite stabilizers, hindered phenol stabilizers, hindered amine stabilizers, aromatic amine stabilizers, thioesters, and phenolic based anti-oxidants. When present, the one or more antioxidants comprise from at or about 0.1 to at or about 3 wt-%, or preferably from at or about 0.1 to at or about 1 wt-%, or more preferably from at or about 0.1 to at or about 0.7 wt-%, the weight percentage being based on the total weight of the resin composition.

The resin composition described herein may further comprise one or more impact modifiers. Preferred impact modifiers include those typically used for polyamide compositions, including ionomers, carboxyl-functionalized polyolefins, and/or mixtures thereof. When present, the one ore more impact modifiers preferably comprise up to at or about 10 wt-%, or more preferably from at or about 0.5 to at or about 5 wt-%, the weight percentage being based on the total weight of the resin composition.

The resin composition described herein may further comprise ultraviolet light stabilizers such as hindered amine light stabilizers (HALS), carbon black, substituted resorcinols, salicylates, benzotriazoles, and benzophenones.

The resin composition described herein may further comprise modifiers and other ingredients such as for example flow enhancing additives, lubricants, antistatic agents, coloring agents, flame retardants, nucleating agents, crystallization promoting agents and other processing aids known in the polymer compounding art.

Fillers, modifiers and other ingredients described above may be present in the resin composition in amounts and in forms well known in the art, including in the form of so-called nano-materials where at least one of the dimensions of the particles is in the range of 1 to 1000 nm.

The resin compositions described herein are melt-mixed blends, wherein all of the polymeric components are well-dispersed within each other and all of the non-polymeric ingredients are well-dispersed in and bound by the polymer matrix, such that the blend forms a unified whole. Any melt-mixing method may be used to combine the polymeric components and non-polymeric ingredients of the present invention. For example, the polymeric components and non-polymeric ingredients may be added to a melt mixer, such as, for example, a single or twin-screw extruder; a blender; a single or twin-screw kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained. For improving the processing of the resin composition comprising at least one polyamide and a natural fiber material as described above, it is preferred that the water content of the natural fiber material is less than at or about 5 wt-%, and more preferably less than at or about 2 wt-%, the water content being expressed as a percentage by mass and being being measured according to ISO 15512/B (the Karl Fischer method). If the water content of the native natural fiber material is more than 5 wt-% or preferably more than 2 wt-%, the natural fiber material may be dried to the desired value by conventional means such as for example by heating the natural fiber material in an oven for several hours under nitrogen.

In another aspect, the present invention relates to a method for making an electronic device housing by injection moulding. The following examples are provided to describe the invention in further detail. These examples, which set forth a preferred mode presently contemplated for carrying out the invention, are intended to illustrate and not to limit the invention.

### EXAMPLES

The following materials were used for preparing the resin composition according to the present invention and the comparative examples:

Polyamide: polyamide made of sebacic acid and decamethylene diamine (PA 10,10) having a pMC of 99% as determined with according to ASTM-D6866 method B. ASTM-D6866 Biobased Determination method was conducted by Beta Analytics Inc. Miami Fla., USA, to determine the % biobased carbon.
Natural fiber material 1: kenaf fibers having an average diameter of about 50 microns and a minimum length of about 3 mm, as measured by electron microscopy. These fibers are supplied by Holstein-Flachs GmbH, Germany under the name kenaf type KE.
Natural fiber material 2: flax having an average diameter of about 25 microns and a length bigger than 3 mm, as measured by electron microscopy. These fibers are supplied by Holstein-Flachs GmbH, Germany under the name flax type KAE.

### Compounding

Prior to compounding the natural fiber materials and the polyamide, the natural fiber materials were dried 20 hours at 80° C. in an oven under nitrogen so as to have a water content less than 2 wt-%, the weight percentage (water content) being based on the total weight of the natural fiber material and being measured by the Karl Fischer method according to ISO 15512/B. After 20 hours at 80° C. under nitrogen, the water content of the natural fiber material 1 was 1.71 wt-% and the water content of the natural fiber material 2 was 1.99 wt-%.

The compositions of Examples were prepared by melt blending the ingredients shown in Table 1 in a 40 mm twin screw extruder (Berstorff ZE40) using a screw speed of about 200 rpm and a melt temperature measured by hand of about 245° C. Ingredient quantities shown in Table 1 are given in wt-% on the basis of the total weight of the resin composition.

The compounded mixture was extruded in the form of laces or strands, cooled in a water bath, dried, chopped into granules and placed into sealed aluminum lined bags in order to prevent moisture pick up. The is cooling and cutting conditions were adjusted to ensure that the materials were kept below 0.2% of moisture level.

### Mechanical Properties

Tensile moduli were measured according to ISO 527-2/1B/1. Measurements were done on injection molded ISO bar samples (melt temperature: about 226° C.; mold temperature: about 90° C. and a hold pressure of 90 MPa) with a thickness of the test specimen of 4 mm and a width of 10 mm according to ISO 527. The test specimens were measured at 23° C. dried as molded (DAM).

Mechanical properties were measured for 6 test specimens made of the resin composition according to the present invention (E1-E2) and test speciments made of the comparative composition (C1) and the results are the average of them. The results are shown in Table 1 under the headings of “tensile modulus” and “stress at break”.

TABLE 1

| | C1 | E1 | E2 |
|---|---|---|---|
| Polyamide | 100 | 75 | 80 |
| Glass fibers | | | |
| Natural fiber material 1 | — | 25 | — |
| Natural fiber material 2 | — | — | 20 |
| Tensile modulus/GPa | 1.6 | 3.5 | 3.3 |
| Stress at break/MPa | 44 | 65 | 58 |

What is claimed is:

1. An electronic device housing made of a resin composition comprising:
a) at least one polyamide; and
b) a natural fiber material.

2. The electronic device housing according to claim 1, wherein the at least one polyamide has a melting point less than or equal to 230° C., as determined with the norm ISO 3146C.

3. The electronic device housing according to claim 1 or 2, whereine the at least one polyamide is selected from polyamide 11, PA6,10; PA6,14; PA10,10; PA10,12; PA1014; PA12,10; PA12,12; PA610/6T; PA612/6T; PA1010/10T and copolymers and mixtures of the same.

4. The electronic device housing according to claim 3, wherein the at least one polyamide is polyamide 10,10.

5. The electronic device housing according to any preceding claim, wherein the at least one polyamide has a carbon content of at least 50 percent modern carbon, as determined with ASTM-D6866 method B.

6. The electronic device housing according to claim 5, wherein the at least one polyamide has a carbon content of at least 90 percent modern carbon, as determined with ASTM-D6866 method B.

7. The electronic device housing according to any preceding claim, wherein the natural fiber material comprises at least one of the group consisting of kenaf, flax, wood, cotton, wool, bamboo, hemp, ramie, sisal, linen, jute, silk, grasses, rice hulls, bagasse and mixtures thereof.

8. The electronic device housing according to claim 7, wherein the natural fiber material comprises at least one of the group consisting of kenaf, flax, wood, cotton, wool, and/or mixtures thereof.

9. The electronic device housing according to any preceding claim, wherein the natural fiber material has an average diameter from at or about 5 to at or about 60 microns.

10. The electronic device housing according to any preceding claim, wherein the natural fiber material has an average length from at or about 1 to at or about 70 mm.

11. The electronic device housing according to any preceding claim, wherein the at least one polyamide is present from at or about 40 to at or about 95 wt-%, the weight percentage being based on the total weight of the resin compostion.

12. The electronic device housing according to any preceding claim, wherein the natural fiber material is present from at or about 5 to at or about 60 wt-%, the weight percentage being based on the total weight of the resin compostion.

13. The electronic device housing according claim 12, wherein the natural fiber material is present from at or about 5 to at or about 40 wt-%, the weight percentage being based on the total weight of the resin compostion.

14. The electronic device housing according claim 12 or 13, wherein the natural fiber material is present from at or about 5 to at or about 30 wt-%, the weight percentage being based on the total weight of the resin compostion.

15. The electronic device housing according to any preceding claim, wherein the resin composition further comprises one or more reinforcement agents selected from glass reinforcement agents and fillers, said fillers selected from the group consitsing of calcium carbonate, carbon fibers, talc, mica, wollastonite, calcinated clay, kaolin, magnesium sulfate, magnesium silicate, barium sulphate, titanium dioxide, sodium aluminum carbonate, barium ferrite, potassium titanate and mixtures thereof.

16. The electronic device housing according to any preceding claim, wherein the resin composition further comprises one or more compatibilizing agents and/or sizing agents, the weight percentage being based on the total weight of the resin composition.

17. The electronic device housing according to any preceding claim, wherein the resin composition further comprises one or more antioxidants, the weight percentage being based on the total weight of the resin composition.

18. The electronic device housing according to any preceding claim, wherein the resin composition further comprises one or more impact modifiers, the weight percentage being based on the total weight of the resin composition.

19. The electronic device housing according to any preceding claim, wherein the electronic device is a hand held electronic device.

20. The electronic device housing according to claim 19 in the form of a mobile telephone housing.
